(19) United States
(12) Patent Application Publication
(10) Pub. No.: US 2004/0005435 A1
(43) Pub. Date: Jan. 8, 2004

(54) 3-Dimensionally (3-d) stitched fabrics

(76) Inventors: Hota V.S. GangaRao, Morgantown, WV (US); Vimala Shekar, Morgantown, WV (US); Hemanth K. Thippeswamy, Reston, VA (US)

Correspondence Address: Steptoe & Johnson, Bank One Center Sixth Floor, PO Box 2190, Clarksburg, WV, 26302-2190, US

(21) Appl. No.: 10/363,868

(22) PCT Filed: Sep. 8, 2001
(86) PCT No.: PCT/US01/28080

(51) Int. Cl. B32B 3/06

(52) U.S. Cl. 428/102; 428/223

(57) ABSTRACT

A fabric architecture (100) made of a plurality of composite fabric layers having a top surface, a first dimension, a second dimension, and a third dimension, wherein the third dimension is the thickness of the fabric architecture, and a plurality of vertical stitches or staple through the fabric layers along the third dimension. The vertical stitching (108), or staples, in the third dimension increases the stiffness and strength of the fabric architecture as well as prevents premature cracking and breaking of a composite component made from the vertical stitching (108) or staples.

### CROSS-REFERENCE TO RELATED APPLICATIONS

This application claims priority from U.S. provisional application No. 60/231,720 filed on Sep. 8, 2000.

### BACKGROUND OF THE INVENTION

1. Field of the Invention

This invention relates generally to composite fabric architectures, and, more particularly, to multiple layers of composite fabrics held together by a resin and by stitching or stapling in the vertical direction.

2. Related Art

Fiber reinforced polymer (FRP) composite materials and structural components with continuous fibers and fabrics have been gaining importance in the construction industry and for civil infrastructure applications, e.g., bridges and decks. These composite materials have shown their superiority over metal in applications requiring high strength to weight ratio, high stiffness to weight ration, excellent fatigue and corrosion resistance, as well as, energy absorption.

The first generation of composite materials consisted mainly of unidirectional fibers. However, a major disadvantage of unidirectional fiber composites is the development of premature cracking due to low stiffness and strength properties in a direction perpendicular to the main reinforcement. To overcome this problem, two-dimensional (2-D) fabrics, having fibers laid in two directions on a horizontal plane, were developed to manufacture composite structural components. Composite materials made of 2-D fabrics have good mechanical properties in the plane of reinforcement, but possess low through-thickness strength and stiffness. That is, 2-D composite fabrics have a relatively low strength to thickness ratio, wherein the strength of thick composite fabric architectures (about 0.75 inches and above) is dramatically reduced to up to fifty percent (50%) of thin composite fabric architectures. Therefore, under static and fatigue loading, these 2-D composite fabrics suffer cracking of matrix and fibers, together with delamination, and ply-by-ply failure (interlaminar shear failure) between plies.

To improve through-thickness (third direction) properties of composite fabrics, multi-axial woven, braided, stitched fabrics were developed which improved interlaminar shear strength and reduced delamination. Although these multi-axial woven and braided composite fabrics offered excellent mechanical properties, the multi-axial weaving and braiding processes are time consuming and require specially designed weaving and braiding machines.

Therefore, there is a need for a three-dimensional (3-D) composite fabric architecture that exhibits a higher stiffness and strength ratio, especially a higher interlaminar (or through-thickness) shear strength, more tolerance to damage, and better impact resistance. In addition, there is a need for a 3-D composite fabric architecture that has a higher energy absorption capability such that any failure is gradual and less catastrophic than conventional fabric architectures that have fibers laid only in the horizontal plane.

In an effort to improve further the mechanical properties of 3-D composite fiber architectures, the 3-D composite fiber architectures were stitched in either one or two directions along a horizontal plane. Although stitching increased the structural integrity of the 3-D composites fabrics, it also caused fiber damage. The factors influencing the extent of fiber damage are: alignment of fibers, manufacturing process, stitch density, type of thread used for stitching, and type of needle tip used for stitching.

U.S. Pat. No. 4,550,045 to Hutson (“the '045 patent”) discloses a fabric architecture having at least three layers of parallel structural fibers wherein the vertical relationship of the layers and the parallelity of the fibers is maintained by stitching through all of the layers of fabric along a horizontal plane. The preferred embodiment for stitching is 4-12 stitches per inch in a predefined pattern across the top horizontal plane of the layers of fabric. The preferred thread used for the horizontal stitching is most natural and virtually all manmade fibers, e.g., glass, kevlar, graphite, polyester and nylon.

The disadvantage with the '045 patent is that it is limited to at least 3 layers of fabric having a stitch density of 4-12 stitches per inch, wherein the layers of fabric are stitched only in the horizontal plane. In addition, there is no discussion as to the fiber content or composition of the fabric layers being stitched together, the method of manufacture, or the alternating of the type of thread used to stitch the fabric together.

Therefore, there is a need for a method for stitching multiple layers of composite fabric in the vertical direction, or third dimension, as a means for strengthening the resulting fabric architecture.

### SUMMARY OF INVENTION

The present invention solves the problems of conventional composite fabric architectures by providing a fabric architecture having a plurality of layers of composite fabric stitched, or stapled, together in the vertical plane. The layers of fabric are stitched along the plane of the thickness of the fabric architecture, i.e., across the seam(s) of the layers of fabric. That is, the stitching is perpendicular to the horizontal plane of layers of fabric.

There are several advantages of stitching layers of fabric in the vertical direction over unstitched fabrics or fabrics that are stitched in the horizontal plane. First, mechanical strengths of fabric architectures using 3-D vertical stitching are at least two times higher than the composite fiber architectures using only the conventional horizontal stitching. Thus, the present invention reduces the number of layers of fabric needed to achieve identical strength and stiffness effects as found in 2-D stitched fabric architectures. Second, stiffness of 3-D stitched fabric architectures is about 30 to 40 percent higher than 2-D stitched fabric architectures. Third, 3-D stitched fabric architectures exhibit higher energy absorption capability, including more favorable failure modes, wherein fabric architectures of the present invention prevents catastrophic, e.g., brittle, failures because unstitched fabrics have sudden breakage without warning or sagging before such a failure. In addition, the layers of fabric now work together in unison wherein all layers of fabric receive and handle the same level of stress, thereby improving shear resistance, as well as, exhibit better thermal coefficients and lower shrinkage related to distress than found in 2-D stitched fiber architectures.

### DESCRIPTION OF FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A is a perspective view of a fabric architecture of the present invention;

FIG. 1B is a perspective view of an alternative fabric architecture;

FIG. 2A is a planar cross-sectional view of the fabric architecture;

FIG. 2B is a planar top view of the fabric architecture;

FIG. 3 is a planar top view of an alternative stitching pattern;

FIG. 4 is a planar cross-sectional view of a fabric architecture having a box pattern of vertical stitching; and

FIG. 5 is a planar cross-sectional view of the fabric architecture having a zig-zag pattern of vertical stitching.

### DETAILED DESCRIPTION

A. Fabric Architecture

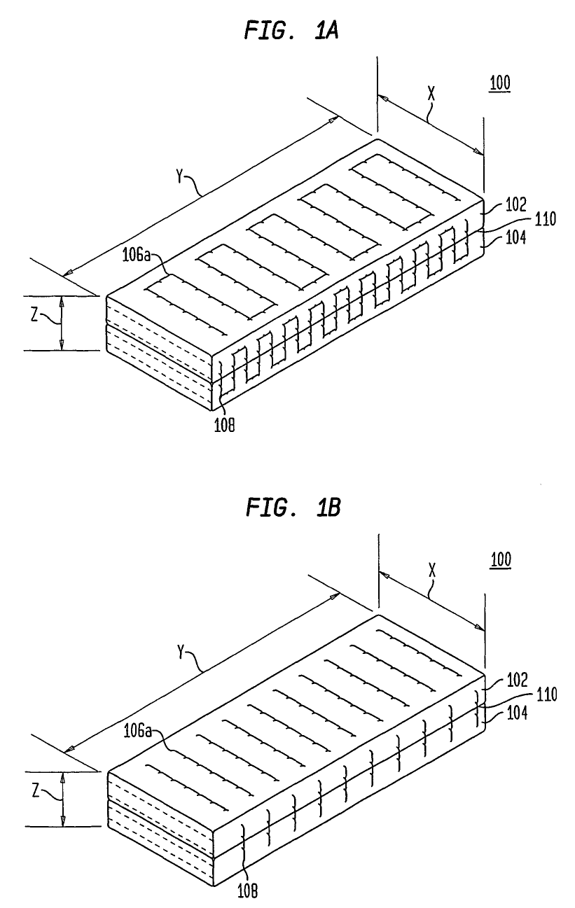

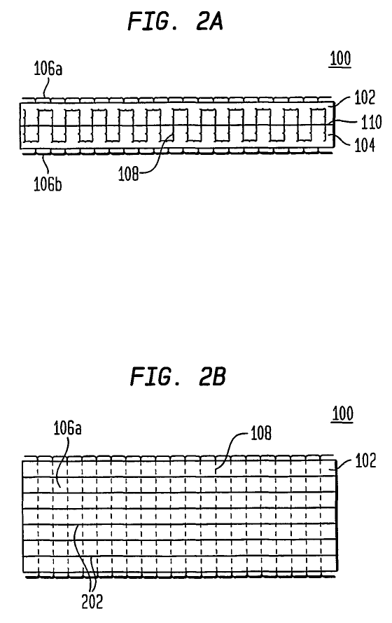

The fabric architecture of the present invention is a plurality of layers of composite fabric stitched together in the vertical plane. FIGS. 1A and 1B are perspective views of a fabric architecture 100 of the present invention, wherein FIGS. 2A and 2B are planar views. For convenience purpose only, the fabric architecture 100 of the present invention is described in terms of a first layer of fabric 102 on top of and secured with a second layer of fabric 104, thereby creating a fabric seam 110. It would be readily apparent to one of ordinary skill in the relevant art to design and manufacture a fiber architecture 100 of the present invention having more than two layers of fabric. Although any number of layers of fabric could be used, the preferred number of layers of fabric is within the range of 2-12 layers, resulting in the thickness of the preferred fabric architecture 100 being within the range of about 0.05 inches to about 1.0 inch.

In addition, the present invention is described in terms of vertical stitching 108, but this is also for convenience purpose only. It would be readily apparent for one of ordinary skill in the relevant art to use a comparable means for securing vertically multiple layers of fabric 102, 104 in the third dimension. For example, the fabric architecture 100 of the present invention may be secured in the vertical plane by one or more staples.

Each layer of fabric, such as the first layer of fabric 102 and the second layer of fabric 104, is a conventional fabric made by conventional means. Each layer of fabric 102, 104, comprising rovings in multiple directions of the horizontal plane, is stitched by horizontal stitching 106a,b in the first and/or second dimensions (X, Y) of the fabric architecture 100. That is, the horizontal stitching 106a of the first layer of fabric 102 passes through that first layer of fabric 102, while the horizontal stitching 106b of the second layer of fabric 104 passes through that second layer of fabric 104.

In the present invention, the first layer of fabric 102 is secured to the second layer of fabric 104 by vertical stitching 108, or stapling as described above. Vertical stitching 108 occurs along the third-dimension (Z) or side or thickness of the fabric architecture 100 such that the vertical stitching 108 crosses the fabric seam 110 and extends through the entire fabric architecture 100. The vertical stitching 108 of the present invention minimizes the horizontal stitching 106a, b needed in the first layer of fabric 102 and second layer of fabric 104.

In one embodiment, the vertical stitching 108 is made in one dimension only resulting in two or more parallel columns, see FIG. 1B, wherein the preferred spacing between columns of vertical stitching 108 is about ¼ of an inch to about ¾ of an inch. In addition, the horizontal stitching 106a, b may also be made in one dimension only resulting in two or more parallel row on a layer of fabric 102. 104. See FIG. 1B. Alternatively, adjacent horizontal stitching rows can be continuous or connected, see FIG. 1A, but are preferably independent adjacent rows such that two adjacent rows are not connected together. Likewise, the vertical columns of the vertical stitching 108 can be continuous or connected, see FIG. 1A, but are preferably independent adjacent columns such that two adjacent columns are not connected together.

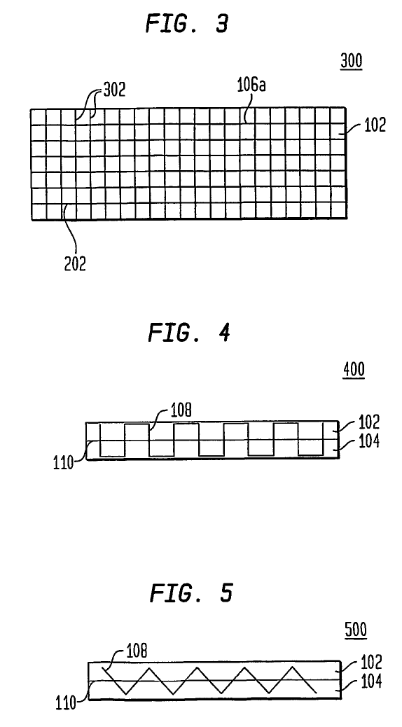

The use of rows for horizontal stitching 106a,b and columns for vertical stitching 108 is for convenience only. The horizontal stitching 106a,b and the vertical stitching 108 can be made in any pattern, e.g., individual rows and columns, zig-zag pattern, box pattern, matrix pattern, etc. For example, in FIG. 3, the horizontal stitching 106a on the first layer of fabric 102 is made in a plurality of rows 202 and a plurality of columns 302 wherein the columns 302 of the horizontal stitching 106a are perpendicular to the rows 202 of the horizontal stitching 106a, thereby making a matrix pattern. The columns 302 are perpendicular to the rows 202 also for convenience purpose. It would be readily apparent to one of ordinary skill in the relevant art to have the columns 302 at a different angle from the rows 202.

Also in the preferred embodiment, the horizontal stitching 106a,b and/or vertical stitching 108 are made from a single type of thread: glass, cotton, yarn, nylon, etc. In alternative embodiments, the horizontal stitching 106a,b and/or vertical stitching 108 may alternate the type of thread used, such that a different type of thread is used at a regular interval, e.g., every other row/column or every third row 202 or column, or at irregular intervals.

Also in the preferred embodiment, the fabric architecture 100 comprises vertical stitching 108 having a vertical stitch density within the range of about 2 to about 10 stitches per inch, wherein a stitch density over 10 stitches per inch results in early stress failure.

Two different patterns of vertical stitching 108 are shown in FIGS. 4 and 5. FIG. 4 shows vertical stitching 108 in a conventional box pattern of squared columns. FIG. 5 shows a zig-zag pattern of vertical stitching 108. The preferred angle between lengths of stitching in the zig-zag pattern is between about 30 degrees to about 60 degrees, with the most preferred angle being about 45 degrees. These patterns are used for convenience purpose only, and it would be readily apparent to one of ordinary skill in the relevant art to use any alternative stitching pattern.

As described above, any conventional fabric can be used as a layer of fabric in the present invention. For example, using the vertical stitching 108 of the present invention, it was found that two layers of bi-axial/quadraxial fabrics are equally as strong and stiff as four layers of biaxial/quadraxial layers of fabric.

B. Method of Manufacture

The method for manufacturing a 3-D fabric architecture 100 of the present invention involves several steps. A first layer of fabric 102, having horizontal stitching 106a, is placed on top of a second layer of fabric 104, having horizontal stitching 106b, thereby creating a plurality of fabric layers having a top surface, a first dimension (X), a second dimension (Y), and a third dimension (Z). The third dimension is the thickness of the fabric layers 102, 104. As stated above, the use of two layers of fabric 102, 104 is for convenience purpose only. Any number of layers of fabric 102, 104 may be used in manufacturing a fabric architecture 100 of the present invention. Once the layers of fabric 102, 104 are positioned on top of each other, they are vertically stitched 108, or stapled, together along the third dimension (Z) or thickness of the fabric architecture 100. The fabric architecture 100 is then immersed in a conventional resin or infused with resin according to conventional methods.

In the present invention, the preferred method for manufacturing a composite, or FRP component using a 3-D fabric architecture 100 is pultrusion, wherein a vertically stitched or stapled fabric architecture is pultruded by conventional means on-line along with rovings and chopped strand mat using conventional methods of pultrusion. In an alternative method of manufacture, a conventional SCRIMP process is used to create a composite component using a vertically stitched or stapled fabric architecture of the present invention.

### CONCLUSION

While various embodiments of the present invention have been described above, it should be understood that they have been presented by the way of example only, and not limitation. It will be understood by those skilled in the art that various changes in form and details may be made therein without departing from the spirit and scope of the invention as defined. Thus, the breadth and scope of the present invention should not be limited by any of the above-described exemplary embodiments.

What is claimed is:

1. A fabric architecture, comprising:
a plurality of fabric layers having a top surface, a first dimension, a second dimension, and a third dimension, wherein said third dimension is along the vertical plane of the thickness of the fabric architecture; and
a plurality of vertical stitches through said plurality of fabric layers along said third dimension.

2. The fabric architecture according to claim 1, wherein said vertical stitches are within the range of about 2-10 stitches per inch.

3. The fabric architecture according to claim 1, wherein said vertical stitches are in one or more columns.

4. The fabric architecture according to claim 3, wherein a first column and a second column of said vertical stitches, wherein said first column is adjacent to said second column, are spaced apart at a distance within the range of about ¼ of an inch to about ¾ of an inch.

5. The fabric architecture according to claim 3, wherein a first column of said vertical stitches is stitched with a first thread type, and a second column of said vertical stitches is stitched with a second thread type.

6. The fabric architecture according to claim 3, wherein a first column of said vertical stitches is connected to a second column.

7. The fabric architecture according to claim 3, wherein one or more columns is eliminated.

8. The fabric architecture according to claim 1, wherein said vertical stitches are in a zig-zag pattern.

9. The fabric architecture according to claim 7, wherein said vertical stitches have an angle within the range of about 30 degrees to about 60 degrees.

10. The fabric architecture according to claim 7, wherein said vertical stitches have an angle of about 45 degrees.

11. The fabric architecture according to claim 1, wherein said vertical stitches are in a box pattern.

12. The fabric architecture according to claim 1, wherein said vertical stitches are made from a thread type selected from the group of glass, yarn, nylon, and cotton.

13. The fabric architecture according to claim 3, wherein said plurality of vertical stitches further comprises one or more columns being at a bias with said one or more rows, wherein two consecutive columns are spaced a distance within the range of about ¼ of an inch to about ¾ of an inch.

14. The fabric architecture according to claim 1, wherein one or more of each fabric layer of said plurality of fabric layers comprises a plurality of horizontal stitches.

15. The fabric architecture according to claim 1, wherein the thickness of the fabric architecture is within the range of about 0.05 inches to about 1.0 inches.

16. A composite component manufactured using the fabric architecture according to claim 1.

17. A fabric architecture, comprising:
a plurality of fabric layers having a top surface, a first dimension, a second dimension, and a third dimension, wherein said third dimension is along the vertical plane of the thickness of the fabric architecture; and
a means for securing the fabric architecture through said plurality of fabric layers along said third dimension.

18. The fabric architecture according to claim 17, wherein said means for securing is stitching.

19. The fabric architecture according to claim 17, wherein said means for securing is one or more staples.

20. A method for manufacturing a fiber architecture, comprising the steps of:
(a) placing a first fabric layer on top of a second fabric layer, creating fabric layers having a top surface, a first dimension, a second dimension, and a third dimension, wherein said third dimension is the thickness of said fabric layers;
(b) vertically securing said plurality of fabric layers along said third dimension, creating the fabric architecture; and
(c) introducing resin into said fabric architecture in resin.

21. The method according to claim 20, wherein said step (b) comprises stitching.

22. The method according to claim 20, wherein said step (b) comprises stapling.

23. The method according to claim 21, wherein the method uses on-line stitching.

24. The method according to claim 20, wherein the method uses resin transfer molding and an even filament winding process.

25. The method according to claim 20, wherein said step (c) comprises immersing said fabric architecture in resin.

26. The method according to claim 20, wherein said step (c) comprises infusing resin into said fabric architecture.

27. A composite component manufactured using a fabric architecture of claim 20 and manufactured using pultrusion or SCRIMP.
